(19) United States
(12) Patent Application Publication
(10) Pub. No.: US 2003/0186797 A1
(43) Pub. Date: Oct. 2, 2003

(54) Method and machine for producing cross-bracing inserts designed for dividing boxes into sections and cross-bracing inserts obtained by said method

(76) Inventors: Jean-Yves Bacques, Paris (FR); Eric Schuster, Thorey-En-Plaine (FR)

Correspondence Address: MERCHANT & GOULD PC, P.O. BOX 2903, MINNEAPOLIS, MN, 55402-0903, US

(21) Appl. No.: 10/343,730

(22) PCT Filed: Jul. 18, 2001
(86) PCT No.: PCT/FR01/02339

(30) Foreign Application Priority Data
Aug. 1, 2000 (FR) 00/10129

(51) Int. Cl. B31B 11/06; B31B 11/12

(52) U.S. Cl. 493/90; 493/379; 493/391; 493/912

(57) ABSTRACT

The invention concerns a method and a machine for automatic production of inserts made of undulated board sheet, for dividing boxes into sections. The method consists in: forming two opposite stacks of blanks, namely one first stack consisting of first blanks (1) designed to form by folding a first part of cross-bracing insert or a first cross-bracing insert, and a second stack of blanks (2) designed to form a second part of cross-bracing insert or a second cross-bracing insert, gripping on one side the first blank (1), and on the other side the second blank (2); simultaneously moving by a pivoting motion the first blank (1) and the second blank (2) so as to bring them in contact with each other by the edge in a common horizontal plane, then in simultaneously folding down on either side of the central panel, the two sets of flaps to form two half-cross-bracing inserts or two cross-bracing inserts

The present invention relates to a method and to a machine for producing cross-bracing inserts intended to divide one or more boxes into compartments, from a set of blanks made of material in corrugated cardboard sheet form, and to the cross-bracing insert or inserts obtained using such a method.

It finds a particularly important, although nonexclusive, application in the field of cross-bracing inserts consisting of intersecting walls in two, generally orthogonal, directions, for compartmentalizing bottles arranged parallel to one another in a packaging.

Cross-bracing inserts for packaging are already known. They are produced either from a set of several slotted cardboard blanks assembled to form the walls of the cross-bracing inserts, or from one-piece blanks.

In the first instance, it is necessary to provide at least two different types of blank, namely one for the longitudinal walls and another for the transverse walls, and this makes the manufacture and putting-together of the cross-bracing inserts more complicated, the assembling of the blanks having always hitherto proved to be a lengthy and expensive process.

In the second instance, that is to say in the case of cross-bracing inserts obtained from one-piece blanks, the disadvantages of the multi-piece cross-bracing inserts are avoided.

Thus, cross-bracing inserts employing gussets which retract as the cross-bracing insert is formed by the folding of flaps, are known.

The main disadvantage with these cross-bracing inserts here lies in the gussets themselves, these being sources of additional thickness and instability because of their elasticity.

There is thus some difficulty experienced in the automatic handling of the cross-bracing inserts in order to insert them into the packages, which difficulty is further exacerbated when the number of compartments in the cross-bracing insert exceeds six because of the proliferation in the number of gussets.

One-piece blanks made of a material in sheet form comprising, on the one hand, two sets of articulated flaps which, by folding, are each able to form part of the compartments of the cross-bracing insert and, on the other hand, an intermediate panel connected to the two sets of flaps respectively along a line which can be broken and along a line which can act as a fold line are also known (FR-A-2-628-397).

Thus, to produce a cross-bracing insert from such a blank, one of the sets of flaps is separated from the intermediate panel, along the line that can be broken, then the sets of flaps are brought into shape to obtain two subsets of compartments, the cross-bracing insert being obtained by standing subsets of compartments back to back against the intermediate panel, one on each side thereof.

These one-piece blanks, as they have just been described, and although advantageous, do have disadvantages.

Specifically, they do not allow for very quick automatic manufacture, particularly because of the prior dividing of the blank into two before the cross-bracing insert is formed.

The present invention aims to provide a method and a machine for forming cross-bracing inserts which is better than those known from the prior art at meeting the practical requirements, particularly in that it will allow high-speed automatic manufacture of cross-bracing inserts at a rate which may touch on thirty cross-bracing inserts per minute, or even sixty cross-bracing inserts in an advantageous embodiment allowing two cross-bracing inserts to be formed simultaneously, and to do so at a cost, an adaptability and a reliability of formation all of which are improved.

To this end, the invention proposes in particular a method for the automatic manufacture of cross-bracing inserts made of sheets of corrugated cardboard for dividing boxes into sections, characterized in that:

once there have been formed two facing piles of blanks, namely a first pile consisting of identical first blanks each formed of a first set of four articulated flaps able, by folding, to form a first part of a cross-bracing insert or a first cross-bracing insert,

and a second pile of identical second blanks each formed of a second set of four articulated flaps able, by folding, to form a second part of a cross-bracing insert or a second cross-bracing insert,

gripping means, using suction, seize, from one side, a first blank and, from the other side, a second blank,

the first blank and the second blank are moved simultaneously, in a pivoting movement, in such a way as to bring the first and second sets of flaps into contact or practically into contact with one another via the edge face in one and the same horizontal plane,

then the two sets of flaps are folded simultaneously on each side of the central panel so as to form two half cross-bracing inserts or two cross-bracing inserts.

In general, the two half cross-bracing inserts will thus allow the formation of a single cross-bracing insert with space for twelve bottles in one and the same case.

By contrast, in the case of the simultaneous formation of two cross-bracing inserts, these will then be cross-bracing inserts each with spaces for six bottles.

In some advantageous embodiments, recourse is further had to one and/or other of the following arrangements:

with the piles of blanks at an angle facing each other, with respect to a vertical plane, the first and second blanks are seized simultaneously then each is brought into contact with the other via a rotational movement one in the opposite direction to the other;

the two half cross-bracing inserts or the two cross-bracing inserts are formed directly by punching in the corresponding box or boxes at the same time as the gripper means go in search of the next blanks.

No lateral movement of the blanks is therefore needed, and this allows high production rates;

with the first set comprising a rectangular first base flap equipped, on a first end side, with a first end flap provided with two notches which are symmetric with respect to an axis of symmetry of the cross-bracing insert and, on the two sides adjacent to said first end side, with two first lateral flaps, also symmetric with respect to said axis, able to be inserted in part into said notches,

and with the second set comprising a second rectangular base flap equipped, on a second end side, with a second end flap provided with two notches which are symmetric with respect to the axis of symmetry of the cross-bracing insert, and on the two sides adjacent to said second end side, with two second lateral flaps, also symmetric with respect to said axis, able to be inserted in said notches,

the two half cross-bracing inserts or cross-bracing inserts are formed by inserting said first and second lateral flaps into the corresponding notches belonging to said facing first and second end flaps;

the second sets of the second blanks are each equipped with a central panel connected to said corresponding second set by a fold line, the second blank being seized by the suction-gripping of the central panel, the latter being positioned vertically and symmetrically between the two sets of flaps in contact or practically in contact with one another;

the central panel is placed in a vertical position only by rotation of the means for the suction gripping of said central panel;

the suction gripper means are moved using a cam and pulleys set.

The invention also proposes a machine for the automatic manufacture of cross-bracing inserts made of sheets of corrugated cardboard for dividing boxes into sections, characterized in that it comprises:

means for storing two facing piles of blanks, namely a first pile consisting of identical first blanks each formed of a first set of four articulated flaps able, by folding, to form a first part of a cross-bracing insert or a first cross-bracing insert,

and a second pile of identical second blanks each formed of a second set of four articulated flaps able, by folding, to form a second part of a cross-bracing insert or a second cross-bracing insert,

means for gripping, by suction, from one side, the first set of flaps of a first blank, and, from the other side, the central panel of a second blank,

means for moving the first blank and the second blank simultaneously in a pivoting movement in such a way as to bring the first and second sets of flaps into contact with one another via the edge face in one and the same horizontal plane,

and means for simultaneously folding the two sets of flaps on each side of the central panel so as to form two half cross-bracing inserts or two cross-bracing inserts.

Advantageously, the storage means are arranged in such a way as to present the piles of blanks at an angle one facing the other, with respect to a vertical plane, and the simultaneous-movement means are arranged in such a way as to bring the blanks respectively into contact with one another by rotating the corresponding gripper means in opposite directions.

Also advantageously, the second sets are each equipped with a central panel connected to said corresponding second set by a fold line, and the machine is arranged in such a way as to place the latter, positioning it symmetrically and vertically, between the first and second sets.

In an advantageous embodiment, the suction gripper means comprise two sets of moving gear, which sets are actuated by the same rotary cam, namely a first set of moving gear equipped with a first piece supporting at least two suction cups, which piece is connected to a first control rod, and a second set of moving gear equipped with a second piece supporting at least two other suction cups, which piece is connected to a second control rod, said control rods being driven by said cam.

Also advantageously, the support means are arranged in such a way as to move said suction cups, in the case of the first support piece, between a first position at an angle, for gripping the first blanks, and a horizontal position for setting said first blanks down, and, in the case of the second piece, between a second position at an angle, for gripping the second blanks, and a horizontal and/or partly vertical position for positioning said second blanks.

In an advantageous embodiment, the support means are equipped with belt-driven pulleys determining the position of the suction cups, said pulleys rotating as one with, or being able to be made to rotate as one with, said support means.

The present invention will be better understood from reading the description which follows of one embodiment which is given by way of nonlimiting example.

The description refers to the accompanying drawings in which:

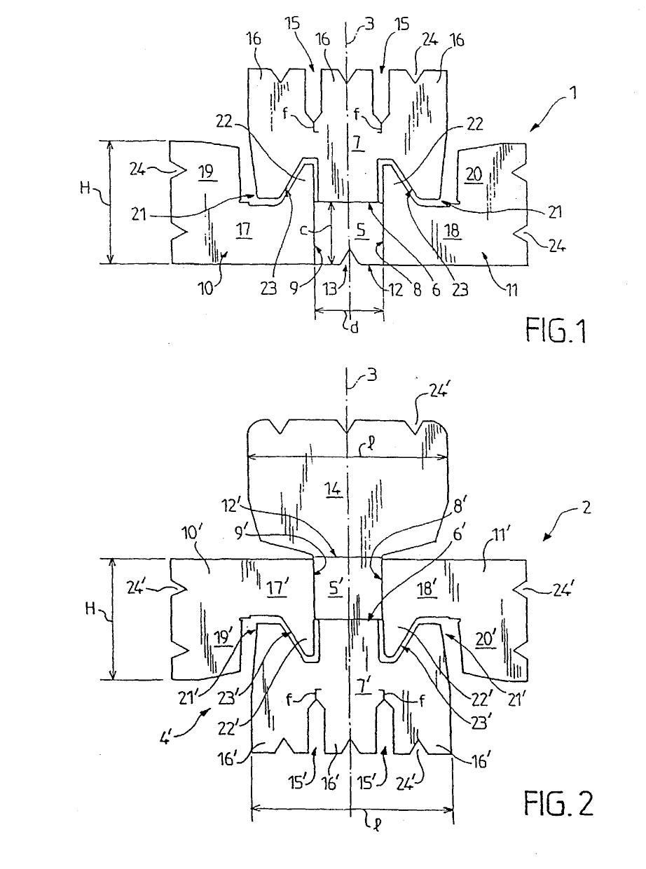

FIG. 1 is a plan view of one embodiment of a first blank that can be applied to the invention.

FIG. 2 is a plan view of an embodiment of a second blank that can be applied to the invention.

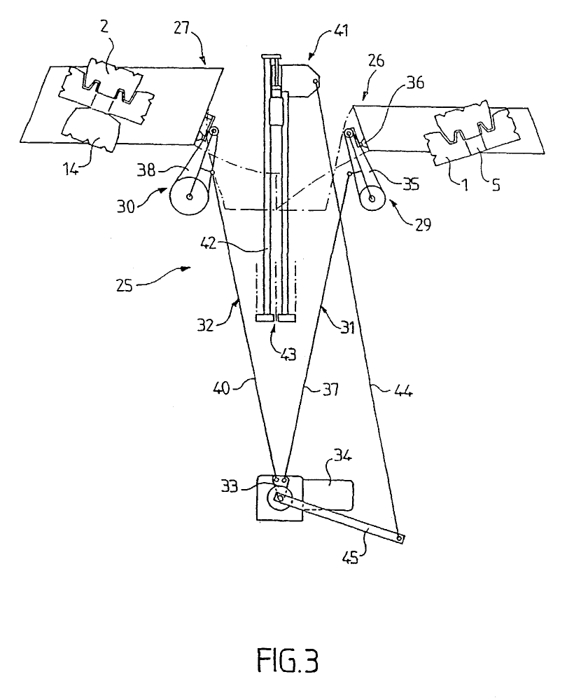

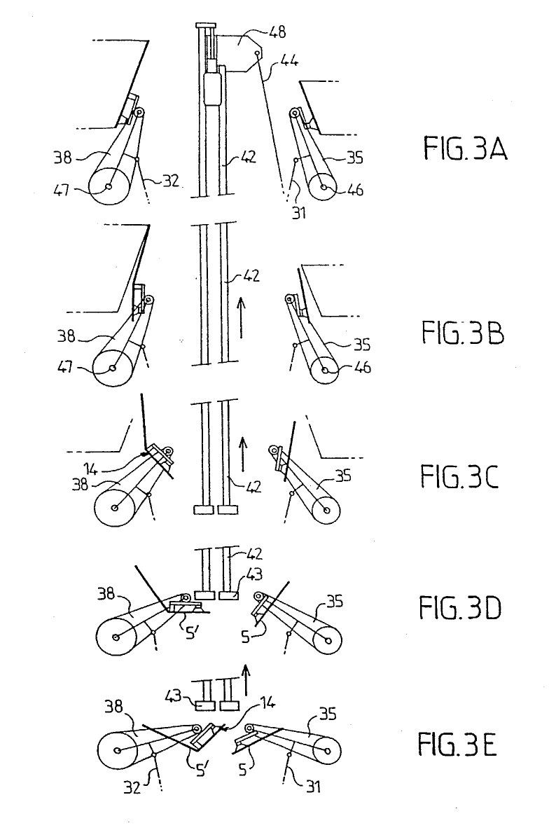

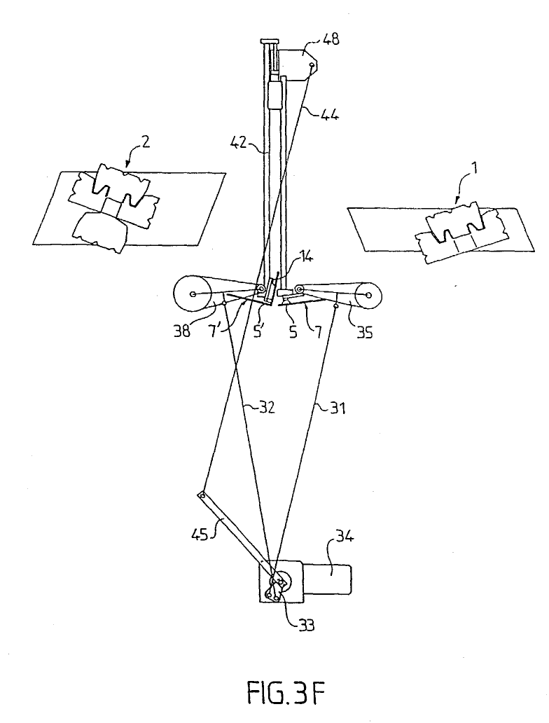

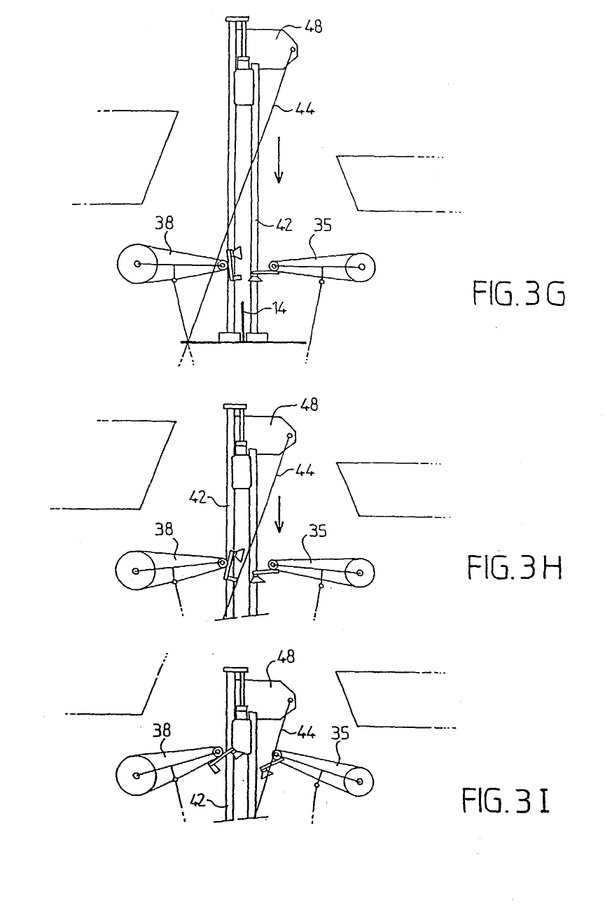

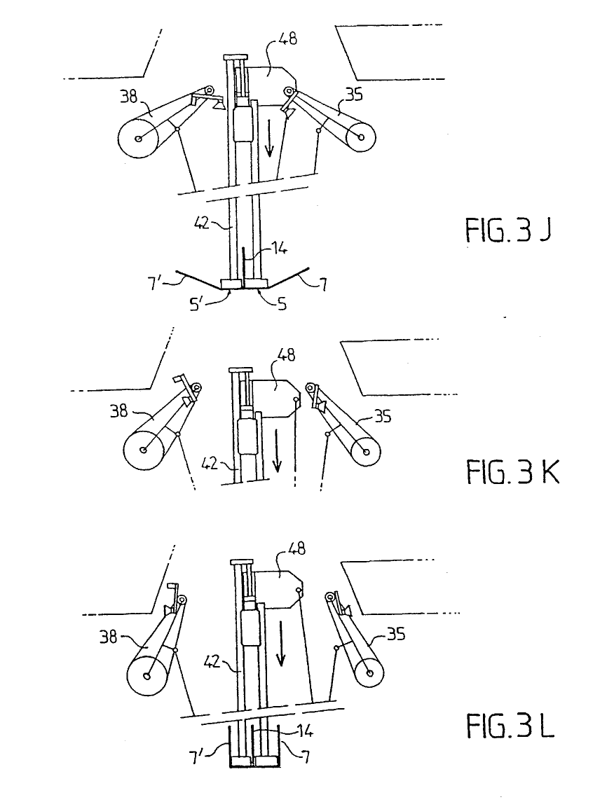

FIG. 3 is a schematic partial side view of one embodiment of the means for forming a cross-bracing insert with a machine according to the invention.

FIGS. 3A to 3G show the bringing of the two blanks into a contact position, according to one embodiment of the method of the invention.

FIGS. 3H to 3L show the next steps of returning the suction cups to their position for gripping the next set of blanks, and of simultaneously punching the previous blanks to form the cross-bracing insert.

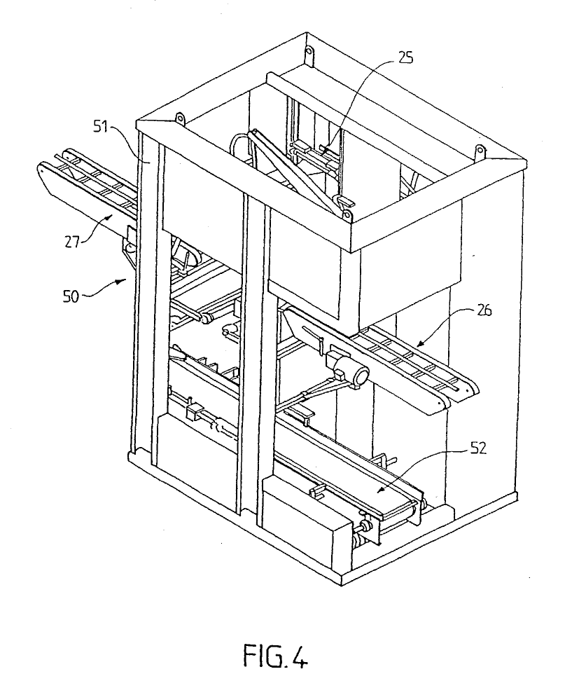

FIG. 4 is a perspective view of a machine according to one embodiment of the invention.

FIG. 5 is a perspective view of the means for gripping, moving and punching the blanks according to the embodiment of the invention more particularly described here.

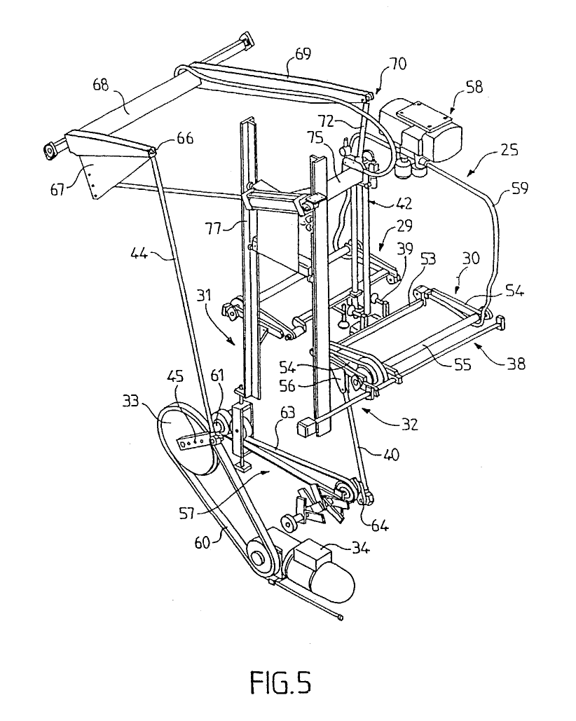

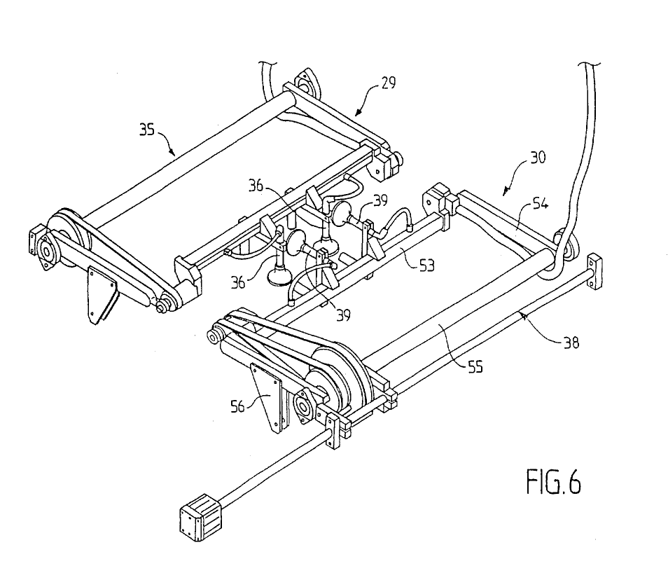

FIG. 6 is a perspective view on a larger scale of the gripping means of FIG. 5.

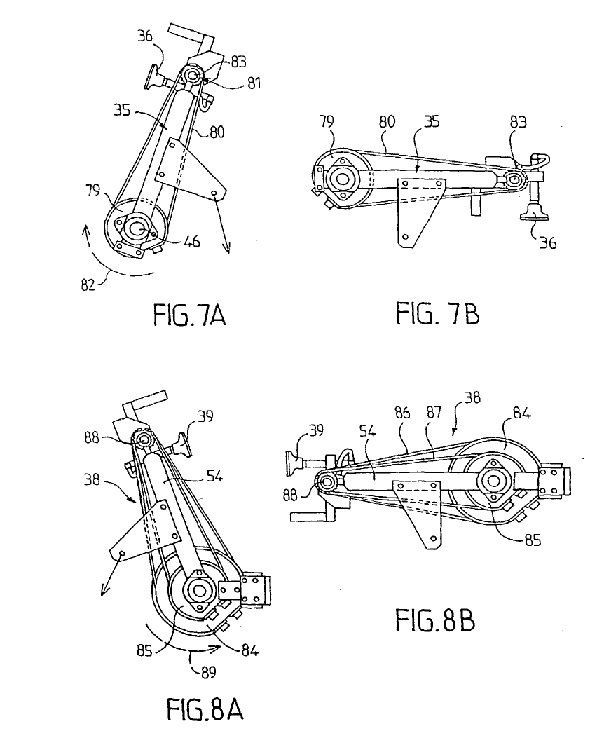

FIGS. 7A, 7B and 8A, 8B are side views of the gripping means with the suction cups for first and second blanks of FIG. 5 respectively in the gripping position and in the release position.

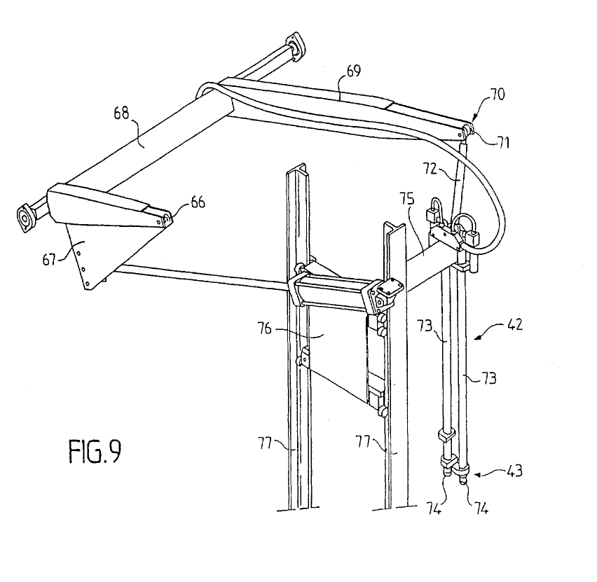

FIG. 9 is a perspective view on a larger scale of the punching means of FIG. 5.

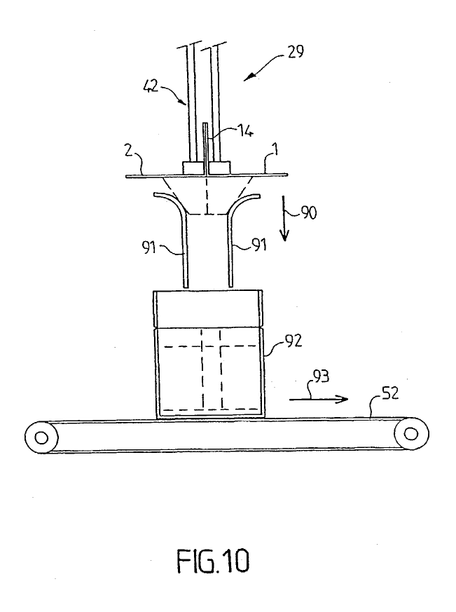

FIG. 10 is a schematic section side view, according to one embodiment, of the lower, box-conveying, part of the machine for forming the cross-bracing insert of the invention.

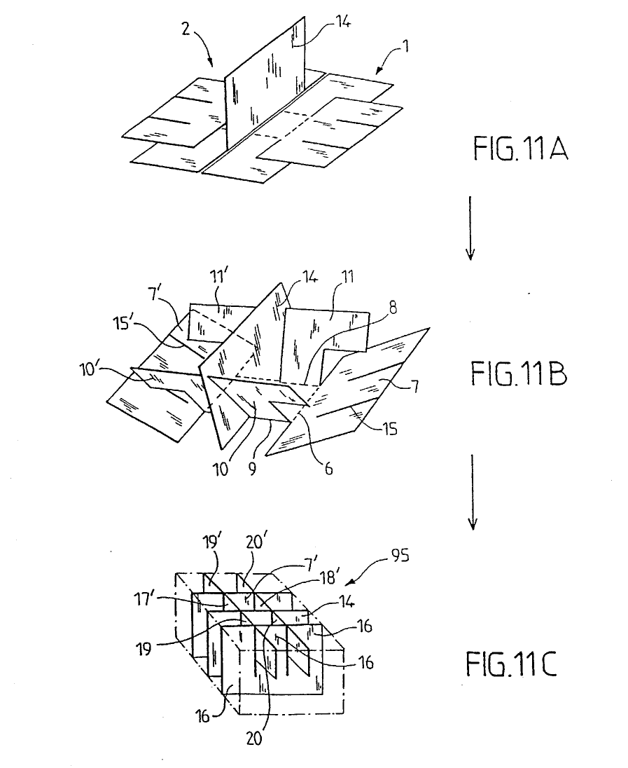

FIGS. 11A, 11B and 11C schematically illustrate the final steps in forming a dividing cross-bracing insert obtained with the method according to the invention, the elements of the machine having been omitted for greater clarity.

In that which follows, the same reference numerals will be used to denote the same elements. In the case of elements which are similar, of the same size, but generally symmetric with respect to an axis, the same reference numerals will be used, but with a prime symbol.

FIGS. 1 and 2 respectively show a first blank 1 and a second blank 2 made of double-sided corrugated cardboard sheet, for example 3 mm thick.

The set of blanks 1 and 2 is intended to form a cross-bracing insert for dividing into compartments a box, for example a crate of wine bottles, which is parallelepipedal, the inside of which will thus be able to be divided into twelve compartments for holding bottles, in a way known per se.

Each of the blanks 1 and 2 is symmetric with respect to a longitudinal axis 3.

More specifically, the blanks 1 and 2 respectively comprise a first set 4 and a second set 4′ of flaps.

Each set of flaps comprises a first or second, rectangular or square base flap 5, 5′ equipped respectively on a first or second end side 6, 6′, with a first or second end flap 7, 7′, and on the two sides 8, 9; 8′, 9′ adjacent to the end sides, with first or second lateral flaps 10, 11; 10′, 11′ respectively symmetric with respect to the axis 3, the sides 6, 6′ and, respectively, 8, 8 and 9, 9′ forming fold lines which are mutually perpendicular one to another.

The base flaps 5, 5′ comprising a fourth side 12, 12′ which, in the case of the flap 5 is free, for example having a V-shaped central notch 13 and which, in the case of the side 12′ which forms a fold line, is equipped with a central panel 14.

The panel 14 has an at least approximately rectangular shape, of length l (perpendicular to the axis 3) for example equal to three times the dimension d of the sides 5, 5′.

Each end flap 7, 7′ is symmetric with respect to the axis 3 and has a dimension perpendicular to the axis 3 equal to the length l of the panel 14.

On the opposite side to the end sides 6, 6′, each end flap 7, 7′ has two notches 15, 15′, parallel to the axis 3, which divides the flap into three strips 16, 16′ of roughly equal width.

These strips are joined together by the rest of the flap, at the base flap 5, 5′ end, and each have a length d, the sides 6, 6′ lying at the base of the strip 16, 16′ at the middle of the end flaps 7, 7′.

Advantageously, the slots 15, 15′ are extended by slots f formed by a small cutting line, which will allow better subsequent nesting-together of the flaps.

The lateral flaps 10, 11 and 10′, 11′ each have at least the approximate shape of a right-angled bracket, with a first branch 17, 18; 17′, 18′ perpendicular to the axis 3 and connected respectively to the corresponding base flap by the fold lines formed by the sides 8, 9; 8′, 9′ of said base flap, and a second branch 19, 20; 19′, 20′, parallel to the axis 3 and arranged laterally with respect to the corresponding end flaps 7, 7′.

A cut out space 21, 21′ separates the end flaps from the lateral flaps, a part 22, 22′ of the corresponding lateral flap for example forming a protruding tab which enters the lower parts 23, 23′ of the lateral strips of the corresponding end flaps 16, 16′.

Advantageously, the height H of the branches 19, 20; 19′, 20′; is approximately twice the length c of the sides 8, 9; 8′, 9′, which may, for example itself be equal to d.

In the embodiment more particularly described here, the flaps and the central panel are equipped on their free edges facing toward the outside of the blank, with triangular notches 24 which allow better contact between the edge faces of the cross-bracing insert once formed, and the walls of the case.

FIG. 3 schematically shows the means 25 for forming a cross-bracing insert by unfolding, joining and punching the blanks, according to the embodiment of the invention more particularly described here.

The machine comprises two magazines 26, 27 for storing blanks facing each other, namely a first magazine 26 for storing first blanks 1 in a roughly vertical position, at an angle, leaning for example at an angle of 30°, toward the means 25, and a second magazine 27 for storing second blanks 2, also in a roughly vertical position for example at an angle leaning toward the means 25 at an angle of the order of 10°.

The piles of blanks are fed laterally in a way known per se by pushing means (not depicted).

The machine also comprises means 29, 30 for gripping, by suction, from one side (means 29), the base flap 5 of the first blank 1 and, from the other side (means 30), the central panel 14 of the second blank 2.

Each means 29, 30 comprises a set of moving gear 31, 32 driven by the one same rotary cam 33, itself driven in terms of rotation by a motor 34.

The first set of moving gear 31 comprises a first piece 35 supporting suction cups 36, which piece is connected to a first control rod 37 and the second set of moving gear 32 for its part comprises a second piece 38 supporting suction cups 39 which are connected to a second control rod 40, said rods being connected in an articulated manner to the cam 33.

The means 25 additionally comprise means 41 for punching the blank once it has been squared, these means comprising a punching column 42 equipped with means 43 for butting against the set of blanks and a rod 44 for driving the column 42 which is mounted to rotate on a link 45 which rotates as one with the cam 33 that drives the gripping means.

The method of producing the cross-bracing insert according to the embodiment of the invention more particularly described will now be described with reference to FIGS. 3A to 3L.

The starting position (FIG. 3A) shows the suction cups 36, 39 of the gripping means 29, 30 in position on the parts 5 and 14 of their respective blanks 1 and 2.

The suction cups are then evacuated by an on-board vacuum circuit (not depicted). On picking up the blanks by suction, they allow the blanks 1 and 2 to become detached from their pile of blanks placed respectively in the magazines 26 and 27, then allow them to be moved as depicted in FIGS. 3B to 3F.

To do this, the elongate support pieces 35 and 38 are mounted so that they can move in terms of rotation about axles 46, 47 placed at one of their ends and mutually parallel. They are driven in terms of rotation by their respective rods 31 and 32.

Each rod is secured, on the one hand, to the pieces (for example at the middle of the length of the corresponding support) and, on the other hand, to the cam system (or cam) 33 driven by the rotary motor 34.

The turning of the cam 33, returning the rods downward, causes the pieces 35 and 38 to pivot in terms of rotation and, through appropriate lateral guidance (not depicted) on the one hand causes the panel 14 of the blank to pivot into a vertical position (cf. FIGS. 3E and 3F) and, on the other hand, causes the sets of flaps of the blanks 1 and 2 to pivot until they are brought into a horizontal position (FIG. 3F) so that they come into contact with one another in the horizontal plane, at the sides 12 and 12′ of the base flaps 5 and 5′.

As can also be seen from FIGS. 3A to 3F, and at the same time as the support pieces are being driven, the knocking column 42 moves between a lowered position at the time of the gripping of the blanks (FIG. 3A) and a raised position (FIGS. 3F and 3G) for which the two blanks are in contact with one another, the panel 14 being vertical between the two.

To achieve this, the link 45, secured on the one hand to the cam 33 and on the other hand to a lug 48 fixed at the upper part of the punching column 42, pivots between a first position (cf. FIG. 3) and a second position (cf. FIG. 3F) subtending an angle between 140° and 200°, for example 160°, allowing the column 42 to be moved between its lowered punching position and its raised position.

More specifically, and making reference to the next FIGS. 3G to 3L, the column 42 descends gradually as the support pieces 35 and 38 rise in search of further blanks, this allowing the blanks thus joined to be knocked out (cf. FIG. 3J or 3L) downward and shaped into the definitive shape of the cross-bracing insert at the same time as the latter is introduced into the box which it will equip (not depicted).

FIG. 4 shows a perspective view of the machine 50 according to the invention.

This machine comprises a support structure 51, for example roughly parallelepipedal, and therefore very compact, a lower conveyor belt 52 for bringing preformed boxes in under the cross-bracing insert forming means 25, and magazines 26 and 27 for storing the blanks 1 and 2.

The storage means comprise elements for supporting the blanks in a leaning, roughly vertical, position, which elements are formed in a way known per se.

The means 25 for forming the cross-bracing insert will now be detailed further with reference to FIGS. 5 to 10.

FIG. 5 is a perspective view of one embodiment of the means 25 for forming the cross-bracing insert according to the invention.

The means 25 comprise the means 29, 30 for gripping the blanks by suction.

Hereafter, the means 30 for gripping the blank 2 will be described, it being understood that the means 29 for gripping the blank 1 are practically identical, except as regards the pulley system which differs partly as will be specified later on.

Also, and with reference to FIG. 6, the means 30 comprise a set of moving gear comprising a support piece 38 formed by a central bar 53 secured to the two suction cups 39 which are fixed toward the center of the bar.

The bar 53 is able to move in terms of rotation about the ends of two lateral angle brackets 54, the other ends of which are secured to a support bar 55 fixed to the structure 51.

One of the lateral angle brackets is fixed in terms of rotation by means of a lateral mounting plate 56 to one end of the rod 40 the other end of which is connected to the device 57 which rotates as one with the cam 33.

Means 58 for supplying vacuum to the suction cups 39 via a suction tube 59 are provided and fixed to the structure.

More specifically, the means 57 according to the embodiment described here comprise a motor 34 for driving the cam 33, via a belt 60.

The cam 33 rotates as one, via a function shaft 61, with a disk 62, itself joined directly to an end mounted on a ball joint, of the rod 37 driving the support piece 35 for the first blank 1, and via a belt 63 and a second disk 64 to an end, here again mounted on ball joint, of the rod 40 driving the support piece 38 for the second blank 2.

The cam 33 also rotates as one with the link 45 the other end of which is secured, via a bearing 65, to a rod 44 for driving the punching column 42 which is also specified with reference to FIG. 9.

The other end of the rod 44 is connected, via a ball joint 66, to a plate 67 secured to an axle 68 itself fixed to an arm 69 the end 70 of which is connected via a ball joint 71 to a punching linkage 72.

The linkage 72 is designed to drive the column 42 vertically between two positions, a raised position for bringing the blanks into contact via the edge face, and a lowered punching position for forming the cross-bracing insert in the box.

Advantageously, the column 42 is formed of two tubes 73, ending at their abutment end 43 in gusseted suction cups 74 supplied with vacuum from the top, by virtue of the vacuum system 58.

The column 42 is also supported horizontally by a crossmember 75 to which it is fixed at one of its ends, the other end of the crossmember 75 being fixed to a piece 76 formed by a plate designed to slide vertically between two vertical guide rails 77.

The suction cup supports for the first and second blanks will now be described more specifically with reference to FIGS. 7A, 7B, 8A and 8B.

FIGS. 7a and 7B show, in a side view, the raised position for the gripping of the first blank by the gusseted suction cups 36 (FIG. 7A) and the lowered, horizontal, position for laying the blank flat (FIG. 7B).

To move from the position for gripping the stored blanks (FIG. 7A) to the laid-flat position (FIG. 7B), the suction cups need to turn through 180° with respect to the branch 78 supporting the suction cups. To achieve this, a pulley 79, which is fixed with respect to the structure, drives, via a belt 80, a pulley 81 which moves as one with the suction cups.

As the support branch rotates in the direction of the arrow 82, the suction cups turn about the axis 83 of the end of said branch to adopt the correct position.

FIGS. 8A and 8B show the system of suction cups 39 associated with the second blank.

FIG. 8A shows the raised position in which the suction cups 39 are parallel to the magazine.

FIG. 8B shows the lowered position with the panel 14 being placed vertically.

For this, a large pulley 84, which may be rendered fixed with respect to the structure, is provided at one end of the support branch 54.

When the intended setup is that of two cross-bracing inserts formed simultaneously, a small pulley 85 is also provided, which pulley may itself too, be rendered fixed in terms of rotation with respect to the structure (the large pulley is then, however, made free).

A double set of belts 86, 87 connected respectively to the pulleys 84 and 85 allows an end pulley 88 to be driven so as to place the suction cups 39, with which it rotates as one, in the correct position during the rotation (arrow 89), that is say either vertical with the large pulley fixed with respect to the structure (as depicted in the figure) or horizontal with the small pulley fixed with respect to the structure (not depicted) in a similar way to FIG. 7B.

FIG. 10 schematically depicts the final formation of the cross-bracing insert by punching in the case.

The ends 43 of the punching column 42, equipped with suction cups, hold the blanks 1 and 2 in square positions.

The column descends in the direction of the arrow 90.

Guiding shapes 91, of which there are, for example, four or eight, in the form of plates curved outward at their upper part, able to close the walls of the cross-bracing insert on itself, are provided. These allow the cross-bracing insert to form itself finally before it enters the case 92 which can then be removed on the conveyor belt 52 (arrow 93).

Finally, FIGS. 11A to 11C depict, under the machine employed for reasons of clarity, the set of blanks 1 and 2 after square presentation (FIG. 11A), then folding by folding of the sides and nesting in the notches 15 of the walls 10, 11, 10′, 11′ (FIG. 11B)

The cross-bracing insert 95 as depicted in FIG. 11C is then obtained and this can be inserted into the internal volume of the case that is to be lined, depicted in chain line 96 in the figure.

As goes without saying and as is also evident from the foregoing, the present invention is not restricted to the embodiments more particularly described. On the contrary, it encompasses all alternative forms thereof, particularly those in which two six-space cross-bracing inserts are formed simultaneously and punched out into two cases underneath in the same movement.

1. A method for the automatic manufacture of cross-bracing inserts made of sheets of corrugated cardboard for dividing boxes into sections, characterized in that:
once there have been formed two facing piles of blanks, namely a first pile consisting of identical first blanks each formed of a first set of four articulated flaps able, by folding, to form a first part of a cross-bracing insert or a first cross-bracing insert,
and a second pile of identical second blanks each formed of a second set of four articulated flaps able, by folding, to form a second part of a cross-bracing insert or a second cross-bracing insert,
gripping means, using suction, seize, from one side, a first blank and, from the other side, a second blank,
the first blank and the second blank are moved simultaneously, in a pivoting movement, in such a way as to bring the first and second sets of flaps into contact or practically into contact with one another via the edge face in one and the same horizontal plane,
then the two sets of flaps are folded simultaneously on each side of the central panel so as to form two half cross-bracing inserts or two cross-bracing inserts.

2. The method as claimed in claim 1, characterized in that with the piles of blanks at an angle facing each other, with respect to a vertical plane, the first and second blanks are seized simultaneously then each is brought into contact with the other via a rotational movement one in the opposite direction to the other.

3. The method as claimed in either one of the preceding claims, characterized in that the two half cross-bracing inserts or the two cross-bracing inserts are formed directly by punching in the corresponding box or boxes at the same time as the gripper means go in search of the next blanks.

4. The method as claimed in one of the preceding claims, characterized in that, with the first set comprising a rectangular first base flap equipped, on a first end side, with a first end flap provided with two notches which are symmetric with respect to an axis of symmetry of the cross-bracing insert and, on the two sides adjacent to said first end side, with two first lateral flaps, also symmetric with respect to said axis, able to be inserted in part into said notches,
and with the second set comprising a second rectangular base flap equipped, on a second end side, with a second end flap provided with two notches which are symmetric with respect to the axis of symmetry of the cross-bracing insert, and on the two sides adjacent to said second end side, with two second lateral flaps, also symmetric with respect to said axis, able to be inserted in said notches,
the two half cross-bracing inserts or cross-bracing inserts are formed by inserting said first and second lateral flaps into the corresponding notches belonging to said facing first and second end panels.

5. The method as claimed in any one of the preceding claims, characterized in that the second sets of the second blanks are each equipped with a central panel connected to said corresponding second set by a fold line, the second blank being seized by the suction-gripping of the central panel, the latter being positioned vertically and symmetrically between the two sets of flaps in contact or practically in contact with one another.

6. The method as claimed in any one of the preceding claims, characterized in that the central panel is placed in a vertical position only by rotation of the means for the suction gripping of said central flap.

7. The method as claimed in any one of the preceding claims, characterized in that the suction gripper means are moved using a cam and pulleys set.

8. A machine for the automatic manufacture of cross-bracing inserts made of sheets of corrugated cardboard for dividing boxes into sections, characterized in that it comprises:
means for storing two facing piles of blanks, namely a first pile consisting of identical first blanks each formed of a first set of four articulated flaps able, by folding, to form a first part of a cross-bracing insert or a first cross-bracing insert,
and a second pile of identical second blanks each formed of a second set of four articulated flaps able, by folding, to form a second part of a cross-bracing insert or a second cross-bracing insert,
means for gripping, by suction, from one side, the first set of flaps of a first blank, and, from the other side, the central panel of a second blank,
means for moving the first blank and the second blank simultaneously in a pivoting movement in such a way as to bring the first and second sets of flaps into contact or practically into contact with one another via the edge face in one and the same horizontal plane,
and means for simultaneously folding the two sets of flaps on each side of the central panel so as to form two half cross-bracing inserts or two two cross-bracing inserts.

9. The machine as claimed in claim 8, characterized in that the storage means are arranged in such a way as to present the piles of blanks at an angle one facing the other, with respect to a vertical plane, and in that the simultaneous-movement means are arranged in such a way as to bring the blanks respectively into contact with one another by rotating the corresponding gripper means in opposite directions.

10. The machine as claimed in either one of claims 8 and 9, characterized in that the suction gripper means comprise two sets of moving gear, which sets are actuated by the same rotary cam, namely a first set of moving gear equipped with a first piece supporting at least two suction cups, which piece is connected to a first control rod, and a second set of moving gear equipped with a second piece supporting at least two other suction cups, which piece is connected to a second control rod, said control rods being driven by said cam.

11. The machine as claimed in any one of claims 8 to 10, characterized in that the support means are arranged in such a way as to move said suction cups, in the case of the first piece, between a first position at an angle, for gripping the first blanks, and a horizontal position for setting said first blanks down, and, in the case of the second piece, between a second position at an angle, for gripping the second blanks, and a horizontal and/or partly vertical position for positioning said second blanks.

12. The machine as claimed in claim 11 dependent on claim 10, characterized in that the support means are equipped with belt-driven pulleys determining the position of the suction cups, said pulleys rotating as one with, or being able to be made to rotate as one with, said support means.

13. The machine as claimed in any one of claims 8 to 12, characterized in that the folding means comprise means for punching out the set of blanks once it has been placed in a horizontal position into one or two boxes brought into position directly above the flap suction means, allowing the automatic forming of one or two cross-bracing inserts by punching in said box or boxes while the gripper means go in search of the next blanks.

14. The machine as claimed in claim 13, characterized in that the punching means are driven by the same cam as the suction gripper means.
